(19) United States
(12) Patent Application Publication
(10) Pub. No.: US 2026/0147722 A1
(43) Pub. Date: May 28, 2026

(54) INPUT/OUTPUT CONDITION DETECTION

(71) Applicant: QUALCOMM Incorporated, San Diego, CA (US)

(72) Inventors: Akshay Goyal, Bijnor (IN); Bhavya Soneta, Indore (IN); Mukesh Kumar Pravinbhai Savaliya, Hyderabad (IN)

(21) Appl. No.: 18/960,478

(22) Filed: Nov. 26, 2024

(51) Int. Cl. G06F 13/20; G06F 13/42

(52) U.S. Cl. CPC G06F 13/20; G06F 13/4282; G06F 2213/0016; G06F 2213/40

(57) ABSTRACT

This disclosure provides systems, methods, and devices for interconnecting components of an electronic device through a serial bus interface that supports detecting input/output data lines that are not operating as expected. In a first aspect, a method includes scheduling data to be transmitted over a plurality of input/output lines (e.g., of the serial bus) in a queue. The method includes determining that the condition is met (e.g., input/outlines are all in a high state) for the plurality of input/output lines prior to transmitting the data over the plurality of input/output lines. The method includes transmitting the data over the plurality of input/output lines in the queue when the condition is met for the plurality of input/output lines. Other aspects and features are also claimed and described.

### TECHNICAL FIELD

Aspects of the present disclosure relate generally to computer information systems, and more particularly, to communications systems for coupling components of computer information systems. Some features may enable and provide improved bus or interconnect capabilities for detecting input/output data lines that are not meeting a condition (e.g., not operating as expected).

### INTRODUCTION

Computer information systems may include many components including expansion circuit boards (such as mother and daughter cards), integrated circuit (IC) devices, and/or System-on-Chip (SoC) devices. The components may include processing circuits, user interface components, storage components, and/or other peripheral components. Communication between components may be implemented using a bus. The bus may be operated in compliance with standards-defined specifications and protocols. One example of such a specification-defined interface to a bus is the Peripheral Component Interconnect Express (PCIe) interface. PCIe provides a shared parallel bus architecture that supports interconnection of two devices using links that include one or more serial, full-duplex lanes.

The value and use of information by individuals continues to increase, as do computational requirements. Computational processes performed by computer information systems rely on busses to transmit interface components, so that each component may perform an assigned task. The tasks may include processing, compiling, storing, and/or communicating information for business, personal, or other purposes thereby allowing users to take advantage of the value of the information. Technology and information handling needs and requirements vary between different users and different applications and different computer information systems, such that there may be differences in how the information is handled, processed, stored, or communicated. The variations in information handling allow for computer information systems to be general or configured for a specific user or specific use, such as financial transaction processing, airline reservations, enterprise data storage, or global communications. The buses that interconnect components of computer information systems components are generally capable of supporting the use of the information to increase the value of the information but also provide specialized features to support certain operations or increase performance when performing certain tasks or kinds of information.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Integrated circuit buses, such as an inter-integrated circuit (I2C) and an improved inter-integrated circuit (I3C) buses, may be serial buses for serial communication between integrated circuits and other digital devices. The I2C and I3C buses may include input/output (I/O) lines, which may include serial data lines and serial clock lines. To facilitate a successful serial transfer of data, the I/O lines are to meet a condition (e.g., be in a “proper,” state), where the I/O lines are operating as expected. For example, the I/O lines may be in a high state (e.g., have a voltage above a threshold voltage) to meet the condition.

If any one of the I/O lines is in a low state (e.g., has a voltage below the threshold voltage), then serial transfers via a serial bus may not be completed and may result in an incomplete transfer. The incomplete transfer may queue on the serial bus, effectively creating a bottleneck in the queue. For example, subsequent transfers waiting in queue after the incomplete transfer may also not be completed until the incomplete serial transfer clears. In some cases, the incomplete transfer may be cleared upon expiration of a transfer timer. Clearing the incomplete transfer may result in hardware overhead (e.g., related to power consumption, system costs, etc.) and/or software overhead (e.g., related to processing time, resources, etc.). For example, software overhead may include latencies associated with waiting for a transfer timeout via the timer and subsequent cancelation of the incomplete transfer in the hardware. Waiting for the transfer timeout may also result in delayed transfers of other transfers that are queued after the incomplete serial transfer. Moreover, waiting for the transfer timeout to occur may result in inefficient usage of processing power at the integrated circuit when attempting to process the incomplete serial transfer, which will ultimately not transfer due to the low I/O line.

To efficiently reduce incomplete transfers, for example, to reduce resource usage (e.g., reduce processing power and time delays associated with attempting to complete the incomplete transfer or waiting for the transfer timer to timeout), the I/O lines that do not meet the condition (e.g., are not “proper” or operating as expected), may be detected prior to queuing the transfer. In this manner, an incomplete transfer may not occur due to I/O lines not meeting the condition and that may result in reducing a queue of transfers that will not be completed and reducing latencies associated with waiting for a timeout when a transfer cannot be completed. That is, the queue will include transfers that may be successfully transferred over the I/O lines that are in a proper state and may otherwise be immediately cleared from the queue upon detection.

For example, prior to queuing a transfer on a serial bus, a hardware component of an integrated circuit, such as a programmable serial engine module, may verify that the I/O lines of the serial bus meet the condition. The condition may include one or more conditions that result in a successful transfer. If any of the I/O lines do not meet the condition, then the hardware may output an error message. If the I/O lines meet the condition, then the hardware may queue the transfer. Accordingly, the hardware of the integrated circuit (e.g., device itself) may verify that the I/O lines meet the condition (e.g., are in the proper state and operating as expected) prior to queueing a transfer, queue the transfer when I/O lines are operating as expected, and perform the queued transfer.

Certain aspects of the disclosure relate to systems, apparatus, methods and techniques for detecting I/O data lines that do not meet a condition for a Peripheral Component Interconnect Express (PCIe) interface or other interface to busses in a computer information system, such as a mobile communication device. The condition may include one or more conditions that result in a successful transfer, such as the I/O data lines being in a high state (e.g., having a voltage above a threshold voltage).

In one aspect of the disclosure, an apparatus includes one or more memories storing processor-executable code and one or more processors. The one or more processors are coupled with the one or more memories and individually or collectively operable to execute the code to cause the apparatus to schedule data to be transmitted over a set of I/O lines in a queue (e.g., serially transmitted). The one or more processors are individually or collectively further operable to execute the code to cause the apparatus to determine that a condition is met for the set of I/O lines prior to transmitting the data over the set of I/O lines. To determine that the condition is met may occur prior to expiration of a timer associated with transmitting the data over the set of I/O lines. To determine that the condition is met may be based at least in part on an idle high state associated with each of the set of I/O lines. The one or more processors are individually or collectively further operable to execute the code to cause the apparatus to transmit the data over the set of I/O lines in the queue when the condition is met for the set of I/O lines. In some examples, apparatus may include a programmable serial engine module, and where the programmable serial engine module determines that the condition is met for the set of I/O lines.

In some examples, the one or more processors are individually or collectively further operable to execute the code to cause the apparatus to reset the set of I/O lines in response to the condition not being met. In some examples, the one or more processors are individually or collectively further operable to execute the code to cause the apparatus to transmit an error event notification indicating that the condition is not met for the I/O lines when the condition is not met. In some examples, the one or more processors are individually or collectively further operable to execute the code to cause the apparatus to determine that the condition is not met for the set of I/O lines based at least in part on an idle low state associated with one or more of the set of I/O lines. In some examples, the one or more processors are individually or collectively further operable to execute the code to cause the apparatus to set a register bit of the programmable serial engine module to indicate an error event when the condition is not met for the I/O lines. In another aspect of the disclosure, a method for performing these operations by a processor by executing instructions stored in a memory coupled to the processor is also disclosed. In an additional aspect of the disclosure, a non-transitory computer-readable medium stores instructions that, when executed by a processor, cause the processor to perform these operations.

The systems, apparatus, methods and techniques may be incorporated into logic circuitry as a bus interface and built in an integrated circuit (IC) on a semiconductor die. The IC may be integrated into other components, such as a central processing unit (CPU) (including an applications processor), a graphics processing unit (GPU), a controller of a storage device, a communications processor (e.g., a wireless modem for 3G, 4G LTE, 5G NR, Wi-Fi, Bluetooth, a wireline transceiver for Ethernet).

The methods and techniques may also or alternatively be incorporated into instructions for storage in memory, such as random-access memory (RAM) or read-only memory (ROM), as firmware or software. The instructions may be executed by the logic circuitry to cause a component executing the instructions to communicate over a bus through the bus interface.

An apparatus in accordance with at least one embodiment includes a bus interface configured to support communications between a first component coupled to a bus and a second component coupled to the bus. The bus interface may include logic configured to perform operations for formatting information and generating signals for transmission on the bus, perform operations for processing signals received from the bus and extracting information from the signals. The bus interface may also include logic configured to perform operations to facilitating connections from the first component to the second component over the bus, such as by performing link training, link negotiation, link monitoring, and/or link adaptation.

In some aspects, the bus interface may be implemented in battery-operated devices, including certain mobile communication devices. Mobile devices may be designed to meet increasingly tighter power consumption budgets in order to increase operating time while operating from a battery or other limited power supply. Aspects of this disclosure may be used in mobile communication devices to improve power efficiency or reduce power consumption when transmitting information between components coupled to a bus. As applications generate continuously-increasing demand for improved communication capabilities including higher data rates, lower data transmission latencies and improved battery conservation, there exists an ongoing need for improved power management that may be addressed by certain aspects of this disclosure.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.).

While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations.

In some configurations, devices incorporating described aspects and features may also include additional components and features for implementation and practice of claimed and described aspects. For example, transmission and reception of wireless signals may include a number of components for analog and digital purposes (e.g., hardware components including antenna, radio frequency (RF)-chains, power amplifiers, modulators, buffer, processor(s), interleaver, adders/summers, etc.). Innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates one example of an apparatus that may be adapted according to certain aspects disclosed herein.

FIG. 2 illustrates an example of an architecture for a Peripheral Component Interconnect Express (PCIe) interface according to certain aspects disclosed herein.

FIG. 3 illustrates an example of an architecture for detecting that an input/output line is not operating as expected according to certain aspects disclosed herein.

FIG. 4 illustrates a flow chart of a method for detecting that an input/output line is not operating as expected according to certain aspects disclosed herein.

FIG. 5 is a block diagram illustrating details of an example wireless communication system according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support data processing, including techniques for communicating data over a serial bus. Aspects of this disclosure provide for operations and components used in those operations for detecting whether input/output (I/O) data lines of the serial bus are not meeting a condition, such that the I/O lines are not operating as expected, prior to queuing a data transfer on the serial bus. For example, an integrated circuit may include a programmable hardware core that supports a wide range of serial interfaces, such as an inter-integrated circuit (I2C) and an improved inter-integrated circuit (I3C), etc. The programmable hardware core may include a serial engine that includes a generic interface (GENI), which may be a programmable module (e.g., hardware) to support the range of serial interfaces. Prior to queuing serial transfers on a serial bus, the GENI may detect whether the I/O lines meet the condition. In some examples, the I/O lines may meet the condition when each of the I/O lines are in a high state (e.g., have a voltage above a threshold voltage), such that the I/O lines are operating as expected and considered to be “proper.”

The GENI may queue the transfer on the serial bus (e.g., of I/O lines) when the I/O lines meet the condition. When the I/O lines do not meet the condition, then the GENI may send an error message to software associated with the programmable hardware core (e.g., an application processor external to the programmable hardware core or software internal or associated with the programmable hardware core). In some examples, the GENI may send the error message before a transfer timer would expire. The GENI may also abort a current transfer that cannot complete (e.g., to prevent bottleneck of transfers) and recover the serial bus for subsequent transfers (e.g., upon confirming that the I/O lines meet the condition).

Particular implementations of the subject matter described in this disclosure may be implemented to realize one or more of the following potential advantages or benefits. In some aspects, the present disclosure provides techniques that may reduce software overhead (e.g., related to processing time, resources, etc.) and/or hardware overhead (e.g., related to power consumption, system costs, etc.). In particular, the techniques described herein may reduce latencies associated with waiting for a timer to expire when a data transfer is incomplete (e.g., due to I/O lines that do not meet the condition associated with a successful transfer). For example, time associated with processing a transfer that will not complete and time associated with correcting hardware resources after the timer expires may be reduced since the techniques described herein facilitate detecting I/O lines that do not meet the condition prior to queuing the transfer on the serial bus, as well as sending an indication of an error upon detection of the I/O lines not meeting the condition (e.g., rather than upon expiration of a timer after the transfer has started and cannot be completed).

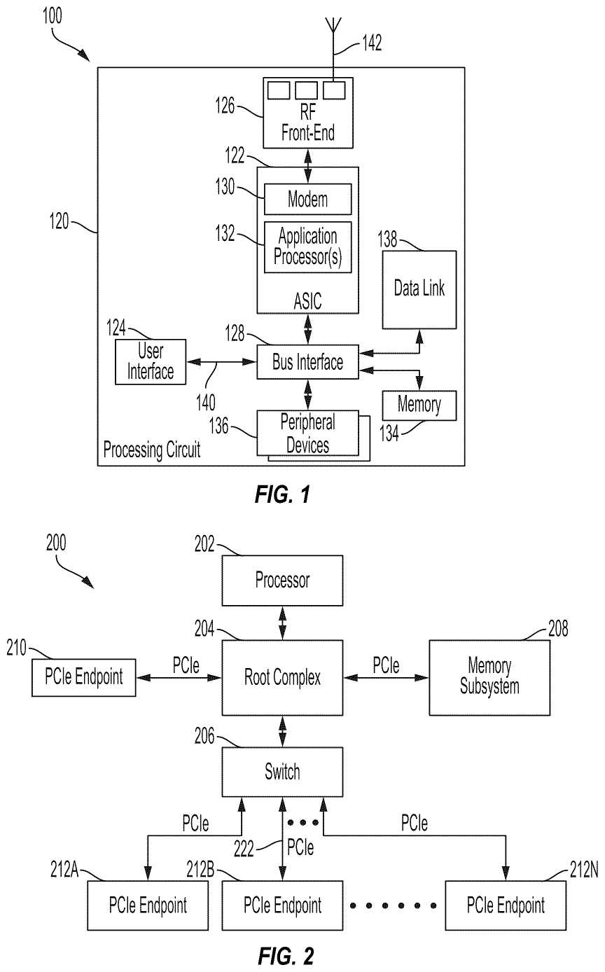

According to certain aspects, a bus interface, such as a PCIe bus interface, may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, or any other similar functioning device. FIG. 1 depicts an example of such an apparatus 100. The apparatus 100 may include a processing circuit 120 having multiple devices or circuits 122, 124, 126, 128, 136, and/or 138. The processing circuit 120 may be implemented in an application-specific IC (ASIC) or system on chip (SoC) that may include multiple devices or circuits 122, 124, 126, 128, 136, and/or 138 as different components that may communicate with each other through busses. In one example, the apparatus 100 may be a communication device and the processing circuit 120 may include a modem 130 that interfaces with a radio frequency (RF) RF front-end circuit 126 that enables the apparatus to communicate through one or more antennas 140 with a radio access network, a core access network, the Internet and/or another network.

The processing circuit 120 includes an application-specific integrated circuit (ASIC) device, which may be a processing circuit device 122, that has one or more application processors 132 (e.g., a heterogenous mix of processors of different configurations, such as performance cores and efficiency cores), one or more modems 130 (e.g., baseband modems), and/or other logic circuits or functions. The processing circuit 120 may be controlled by a basic input/output system (BIOS), firmware, and/or an operating system and may provide an application programming interface (API) layer that enables the one or more processors 132 to execute software modules residing in the memory device 134. The software modules may include instructions and data stored in a processor readable storage such as the memory device 134.

The ASIC device may access an internal memory, the memory device 134, and/or storage devices included in peripheral devices 136 or storage devices outside the processing circuit 120. Memory may include read-only memory (ROM) or random-access memory (RAM), electrically erasable programmable ROM (EEPROM), flash cards, or any memory device that can be used in processing systems and computing platforms. The processing circuit 120 may include, or have access to, a local database or other parameter storage that maintains operational parameters and other information used to configure and operate the apparatus 100 and/or the processing circuit 120. The local database may be implemented using registers, a database module, flash memory, magnetic media, EEPROM, optical media, tape, soft or hard disk, or the like. The processing circuit 120 may also be operably coupled to external devices such as the antennas 140, a display, user interface 124 (e.g., a button, an integrated or external keypad, and/or a touch screen).

The processing circuit 120 may communicate through a bus interface 128 (e.g., bus interface circuit), which may include a combination of circuits, counters, timers, control logic and other configurable circuits or modules. In one example, the bus interface 128 may be configured to operate in accordance with PCIe specifications and protocols. The processing circuit 120 may include or control a power management function that configures and manages the bus interface 128, the user interface 124, the RF front-end circuit 126, and the operation of one or more application processors 132 resident in the ASIC device. In certain modes of operation, the bus interface 128 may be configured to transition between power states based on activity of the bus interface 128.

The bus interface 128 operates using one or more links. In an embodiment of a PCIe interface, the bus interface 128 may operate using high-speed serial links. The PCIe interface 128 may be characterized as having a point-to-point topology, with separate serial links connecting each device to a host, or root complex. FIG. 2 is a block diagram illustrating an example of an architecture for a PCIe interface 200.

In the PCIe interface 200, the root complex 204 couples a processor 202 to memory devices (e.g., the memory subsystem 208) and a PCIe switch circuit 206. In some configurations, the switch circuit 206 includes cascaded switch devices. One or more PCIe endpoint devices 210 may be coupled directly to the root complex 204, while other PCIe endpoint devices 212A, 212B, . . . , 212N may be coupled to the root complex 204 through the PCIe switch circuit 206. The root complex 204 may be coupled to the processor 202 using a proprietary local bus interface or a standards-defined local bus interface. The root complex 204 may control operations of the PCIe interface 200 and may generate transaction requests for the processor 202. In some examples, the root complex 204 is implemented in the same IC device that includes the processor 202. A root complex 204 may support multiple PCIe ports.

The root complex 204 may control communication between the processor 202 the memory subsystem 208 and/or other PCIe endpoint devices 210, 212A, 212B, . . . , 212N. An endpoint device 210, 212A, 212B, . . . , 212N may be defined as a device other than the root complex 204 that is capable of requesting or initiating a PCIe transaction or responding to a PCIe transaction. The PCIe interface 200 may support full-duplex communication between any two endpoints, with no inherent limitation on concurrent access across multiple endpoints.

Information to be communicated using the PCIe interface 200 is encapsulated in packets in accordance with PCIe bus protocols. Devices coupled to a PCIe bus may communicate using one or more PCIe lanes. A PCIe lane may be defined as a point-to-point communication channel between two PCIe ports. A PCIe lane may provide full-duplex communication and may include two differentially encoded pairs of signaling wires or signal traces, with one pair of wires being used for transmitting data and the other pair of wires being used for receiving data. Packets may carry information in eight-bit bytes. In a multi-lane PCIe link, packet data may be striped across multiple lanes. The number of lanes in the multi-lane link may be negotiated during device initialization.

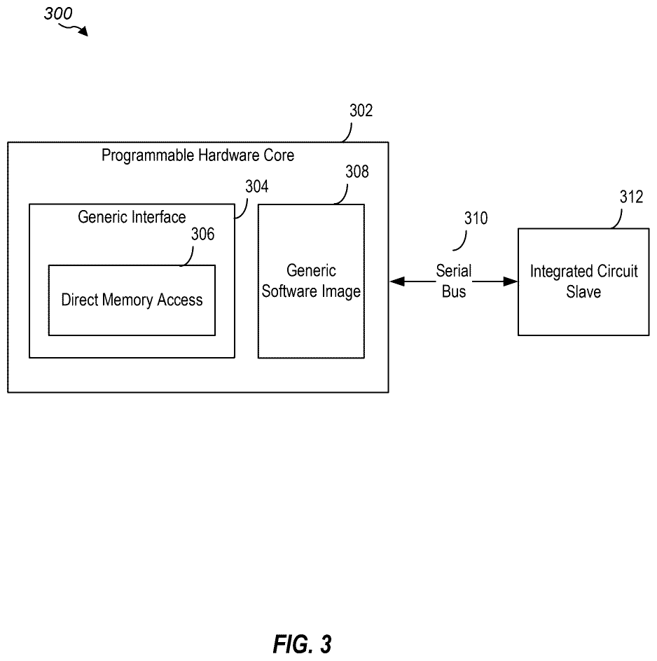

FIG. 3 illustrates an example of an architecture 300 for detecting that an I/O line does not meet a condition according to certain aspects disclosed herein. The architecture 300 may include a programmable hardware core 302 (e.g., a Qualcomm Universal Peripheral (QUP)) communicating with one or more integrated circuit slaves 312 (e.g., I2C or I3C slave device) via a serial bus 310 (e.g., I2C or I3C bus) that includes the I/O lines. The programmable hardware core 302 may include a GENI 304, which includes a direct memory access 306 (DMA). The programmable hardware core 302 may also include a generic software image 308 (GSI). In some examples, the GENI 304 may may include at least one processor, which may be coupled with at least one memory, to, individually or collectively, support or enable the described techniques. For example, the at least one processor and at least one memory coupled with the at least one processor may be configured to perform one or more of the functions described herein (e.g., by one or more processors, individually or collectively, executing instructions stored in the at least one memory).

The GENI 304 may be a programmable serial engine module, which may be embedded in the programmable hardware core 302. The GENI 304 may operate as a controller for various serial interfaces, such as universal asynchronous receiver/transmitter (UART), I2C, I3C, etc., allowing the GENI 304 to support a wide range of communication protocols. For example, the GENI 304 may manage communication protocols and hardware settings for each peripheral, handling communication sequences that ensure efficient data transfer between the programmable hardware core 302 and peripheral devices (e.g., integrated circuit slaves 312). In particular, the GENI 304 of the programmable hardware core 302 (e.g., GENI-based QUP) may integrate the serial interfaces and manage data transfer with either first-in, first-out (FIFO) or DMA modes, facilitating efficient data processing across different types of serial connections. The GENI 304 may include one or more serial engines, which may be managed by a serial engine driver of the GENI 304 that facilitates communication on buses (e.g., the serial bus 310).

The GSI 308 may be a component of the programmable hardware core 302 that generally manages high-throughput data transfers using a DMA controller (e.g., GSI 308 is a DMA-based system) to reduce overhead. For example, the GSI 308 may operate as a high-level interface that manages data transfers queued across multiple peripheral channels, orchestrating the flow of data from a peripheral device (e.g., integrated circuit slaves 312, managed by GENI 304) to system memory (e.g., that may be off-chip or on-chip with respect to the programmable hardware core 302).

That is, and as discussed herein, the GENI 304 may interface directly with the integrated circuit slaves 312 to manage communication protocol specifics while the GSI 308 may work with the GENI 304 to efficiently handle data transfers between the integrated circuit slaves 312 and the system memory.

The serial bus 310 may include one or more I/O lines, which include clock lines and/or data lines. The serial bus 310, including the I/O lines, may meet a condition (e.g., operate as expected or be in a proper state) to successfully perform a serial transfer between the programmable hardware core 302 (e.g., or components of the programmable hardware core 302) and the integrated circuit slave 312. In some examples, the I/O lines of the serial bus 310 may operate as expected when the clock lines and data lines are in an idle or default high state. If any of the I/O lines are in a low state, then the serial transfers to the integrated circuit slave 312 may not be completed and may remain queued on the serial bus 310. That is, if any one of the I/O lines of the serial bus 310 are in a low state, the I/O lines may not meet the condition and may be in an improper or faulty state. Accordingly, the serial transfers that are unable to complete due to the improper I/O lines may result in hardware or software overhead, such as processing and transferring latencies discussed herein.

Some serial bus recovery techniques that may be used when the I/O lines do not meet the condition may include canceling the serial transfer at the hardware (e.g., at the GENI 304 and/or the GSI 308) and recovering the serial bus 310 at the software when a timer expires (e.g., times out). Overhead associated with such recovery techniques may include the software overhead of waiting until the transfer timeout occurs and then canceling the transfer in hardware.

However, such techniques do not allow detection of improper I/O lines, for example, detection in hardware, to reduce or prevent queueing of the transfer on the serial bus 310 that may reduce or avoid the software overhead.

The techniques discussed herein facilitate detection of the I/O lines that do not meet a condition. The condition may be indicative of the I/O lines operating as expected, where one or more conditions may result in a successful transfer. The condition may include each of the I/O lines being in a high state based on a voltage above a threshold voltage for each of the I/O lines. The I/O lines may not meet the condition or be in an improper state when any of the I/O lines are in a low state by having a voltage below the threshold voltage.

For example, when a serial transfer is queued on the serial bus 310, hardware of the programmable hardware core 302 may detect the state of each of the I/O lines (e.g., of the serial bus 310) and proceed with processing the transfer when the I/O lines are determined to meet the condition (e.g., operating properly). However, if the hardware of the programmable hardware core 302 determines that at least one of the I/O lines does not meet the condition, the hardware of the programmable hardware core 302 may send an indication of an error to the software of the programmable hardware core 302. The indication of the error may include that the I/O lines or serial bus 310 does not meet the condition or that the I/O lines are in an improper state. In some examples, the indication may also indicate which I/O lines are not in a proper state, for example, so that they may be reset or resolved.

The software of the hardware of the programmable hardware core 302 may subsequently abort the current transfer and recover the serial bus 310 for the next transfer in queue or that will be in the queue. Aborting the current transfer when the I/O lines do not meet the condition may reduce latencies and software overhead associated with canceling the transfer after the transfer timer expires.

FIG. 3 illustrates the techniques discussed herein. A software of a host of the programmable hardware core 302 (e.g., software associated with an application processor external the programmable hardware core 302) or a software of the programmable hardware core 302 (e.g., serial engine) may receive a transfer request (e.g., from a client or a host device). The programmable hardware core 302 may be associated with different transfer modes including a FIFO mode, a DMA mode, and a GSI mode.

In the FIFO mode, the software (e.g., software associated with the application processor) may program the GENI 304 directly to queue the transfer on the serial bus 310. The software may program registers of the DMA 305 of the GENI 304 (e.g., GENI registers). Data may be transferred between the GENI 304 and the DMA 306 to ultimately queue transfer of data on the serial bus 310.

In the DMA mode, the software may initialize the DMA 306 and a serial engine of the programmable hardware core 302 that is associated with the GENI 304 may configure the GENI 304 to initiate the transfer process.

In the GSI mode, the software may inform the programmable hardware core 302 of the request transfer and may program the GSI 308 to ultimately queue the transfer on the serial bus 310 via the GENI 304. For example, the GSI 308 may program the GENI registers to queue the transfer on the serial bus 310.

In the FIFO mode, the software of the programmable hardware core 302 may program the GENI 304 directly to queue the transfer on the serial bus 310. For example, in the FIFO mode, the software of the programmable hardware core 302 may program registers of the DMA 305 of the GENI 304 (e.g., GENI registers).

As discussed herein, the GENI 304 (e.g., hardware) may check if a condition associated with the I/O lines is met. The GENI 304 make check the I/O lines of the serial bus 310, for example, by checking the GENI registers (e.g., GENI_IOS register), before queueing the transfer on the serial bus 310. The GENI 304 may perform the check in any of the modes (e.g., FIFO mode, DMA mode, or GSI mode).

In some examples, checking that condition is met for the I/O lines may include verifying that each of the I/O lines are in an idle high state or a default high state (e.g., before queuing or before transferring over the I/O lines), where the I/O line is in the high state is the condition. The high state may refer to the voltage associated with an I/O line, and the GENI 304 may confirm that the voltage is a particular voltage or above a threshold voltage. If the condition is met, then the GENI 304 may queue transfer on the I/O lines. If the condition is not met (e.g., the voltage on at least one I/O line is below the threshold voltage), then the GENI 304 may return an error code or message to the software. Accordingly, when the condition is met, the requested transfer is queued to the serial bus 310.

The error indication may interrupt current queuing to reduce latencies otherwise associated with transferring the requested transfer, which will not complete due to the conditions not being met, and waiting for a transfer timer to expire before resolving for the conditions. Accordingly, the error indication facilitates quicker recovery from the faulty I/O line, providing a better user experience by reducing the latencies described herein. Moreover, such latencies or faulty I/O lines may result in system failures.

In some examples, conditions may not be met when a general-purpose input/output (GPIO) for a clock or data line is not configured properly, low-dropout (LDO) powering slave is not powered on, a slave misbehavior that causes holding lines unexpectedly and where the programmable hardware core 302 master is unable to drive the salve, noise on I/O lines, and/or when the GPIOs are multiplexed and used by other subsystems. Such scenarios that may cause the condition to not be met for the I/O lines may apply to any I2C and I3C slaves, such as a display touch (e.g., mobile industry processor interface (MIPI) Touch), inertial measurement units (IMU) sensors, an accelerator, a gyroscope, a keyboard, a touchpad, a camera, a network file system (NFS), an embedded secure element (eSE), and the like.

In some examples, a polling mode may be used to poll for any errors associated with a current transfer and an interrupt mode may be used to interrupt the current transfer upon the error. For example, in the polling mode associated with the GSI mode of operation after queueing a transfer, the GSI 308 may poll to read a GSI interrupt request type (GSI IRQ) (e.g., from the GENI 304), which may be read as an event control command (e.g., EV_CTRL) in a context type interrupt request register (e.g., QUPV3_m_EE_n_CNTXT_TYPE_IRQ register). That is, the GSI 308 may read the error event in an event ring to determine the type of error that occurred on the serial bus 310.

In the interrupt mode associated with GSI mode of operation, the GSI 308 may receive a GSI IRQ that has a type of an event control command (e.g., EV_CTRL) set in a register (e.g., QUPV3_m_EE_n_CNTXT_TYPE_IRQ register). The GSI 308 may read the error event in the event ring to determine the type of error that occurred on the serial bus 310.

In a polling mode associated with the FIFO mode of operation after queueing the transfer, the GENI 304 may poll for an error bit set in a register (e.g., a GENI_M_IRQ_STATUS register). In an interrupt mode associated with the FIFO mode, the GENI 304 may receive a serial engine interrupt request (SE IRQ) with an error bit set in a register (e.g., QUPV3_m_EE_n_CNTXT_TYPE_IRQ register).

In some examples, upon the I/O lines not meeting the condition (e.g., voltage is not at least a threshold voltage indicating high voltage), such that the I/O lines are not operating as expected or may be in an improper state, the hardware of the programmable hardware core 302 may be modified. For example, a hardware register may be updated to indicate to the software that the I/O lines do not meet the condition (e.g., are in an improper state). In particular, for a FIFO mode of operation, one error bit may be set in a register, such as a GENI IRQ STATUS register, indicating that the I/O lines do not meet the condition associated with a proper state of the I/O lines. For a GSI mode of operation, an error event may be set in a GSI event ring to indicate that the I/O lines do not meet the condition associated with a proper state of the I/O lines.

In some examples, to enable detection of the I/O lines not meeting the condition (e.g., voltage is at least a threshold voltage indicating high voltage), such that the I/O lines are not operating as expected or may be in an improper state, the firmware of the programmable hardware core 302 may be updated.

For FIFO mode of operation, the hardware of the programmable hardware core 302 may read a register, such as a GENI_IOS_STATUS register, before initiating transfer on the I/O lines. If at least one of the I/O lines do not meet the condition, then the hardware may set a bit indicating an error, such as in a GENI IRQ STATUS register.

For the GSI mode of operation, the hardware of the programmable hardware core 302 may also read a register, such as to a GENI_IOS_STATUS register, before initiating transfer on the I/O lines. However, if at least one of the I/O lines do not meet the condition, then the hardware may create a GSI error event and write the event to an event ring. For example, to write the event, the hardware may set an event control bit in a register, such as an EVT_CTRL bit in a QUPV3_m_EE_n_CNTXT_TYPE_IRQ register.

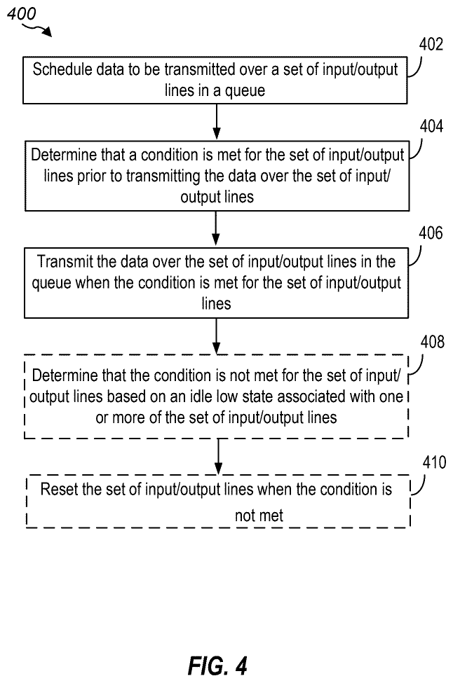

FIG. 4 illustrates a flow chart of a method for detecting that an I/O line is not operating as expected according to certain aspects disclosed herein. The process flow 400 may implement aspects of or may be implemented by aspects of the apparatus 100, the processing circuit device 122, and/or any components of the processing circuit device 122. For example, the process flow 400 may include an apparatus 100 and/or processing circuit device 122 as described herein. In the following description of the process flow 400, the operations performed by the apparatus 100 (e.g., or the processing circuit device 122 and/or components of the processing circuit device 122) may be performed in different orders or at different times than the exemplary order shown. Some operations may also be omitted from the process flow 400, or other operations may be added to the process flow 400. Further, while operations in the process flow 400 are illustrated as being performed by the apparatus 100, the examples herein are not to be construed as limiting, as the described features may be associated with any quantity of different device.

At step 402, the apparatus 100 may schedule data to be transmitted over a set of I/O lines in a queue. The data may be transmitted serially (e.g., over a serial bus made up of the I/O lines).

At step 404, the apparatus 100 may determine that a condition is met for the set of I/O lines prior to transmitting the data over the set of I/O lines. As previously discussed, determining whether the condition is met before queuing the transfer may facilitate in reducing latencies otherwise associated with a timer timeout for clearing the hardware and releasing the serial bus from a pending transfer that will not complete.

At step 406, the apparatus 100 may transmit the data over the set of I/O lines in the queue when the condition is met for the set of I/O lines. In some examples, determining that the condition is met for the set of I/O lines may be based on an idle high state associated with each of the set of I/O lines.

In some examples, as indicated by the dashed line box, at step 408, the apparatus 100 may determine that the condition is not met for the set of I/O lines based on an idle low state associated with one or more of the set of I/O lines. In some examples, determining that the condition is met may occur prior to expiration of a timer associated with transmitting the data over the set of I/O lines.

In some examples, as indicated by the dashed line box, at step 410, the apparatus 100 may reset the set of I/O lines when the condition is not met. In some examples, the apparatus 100 may transmit an error event notification indicating that the condition is not met for the I/O lines when the condition is not met. In some examples, the apparatus 100 may include a GENI, and the GENI may determine that the condition is met for the set of I/O lines. In some examples, the apparatus 100 may set a register bit of the GENI to indicate an error event when the condition is not met for the I/O lines.

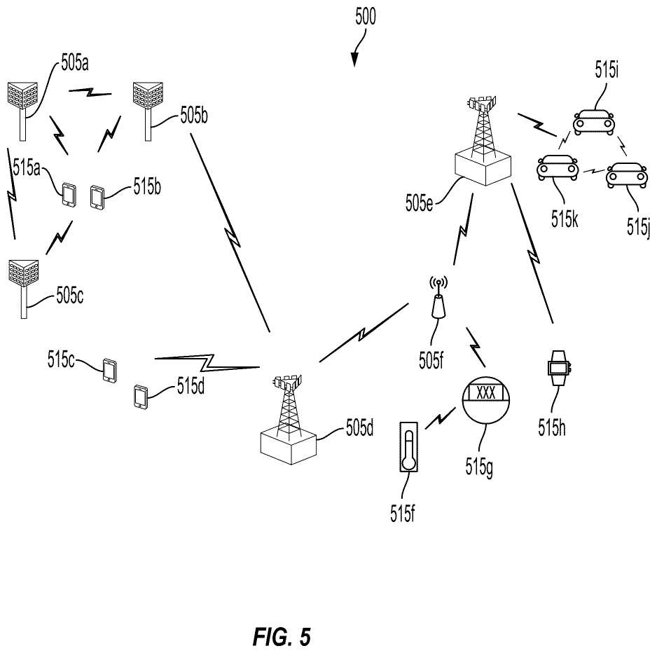

Operations of process flow 400 may be performed by a user equipment (UE), a base station (BS), other communications device, or other computer information system, such as any of the devices described with reference to FIG. 5. For example, example operations (also referred to as “blocks”) of process flow 400 may enable UE 115 to support greater data transfer rates at lower power consumption while communicating over high-speed communications networks. FIG. 5 is a block diagram illustrating details of an example wireless communication system according to one or more aspects. The wireless communication system may include wireless network 500. Wireless network 500 may, for example, include a 5G wireless network. As appreciated by those skilled in the art, components appearing in FIG. 5 are likely to have related counterparts in other network arrangements including, for example, cellular-style network arrangements and non-cellular-style-network arrangements (e.g., device to device or peer to peer or ad hoc network arrangements, etc.).

Wireless network 500 illustrated in FIG. 5 includes a number of base stations 505 and other network entities. A base station may be a station that communicates with the UEs and may also be referred to as an evolved node B (eNB), a next generation eNB (gNB), an access point, and the like. Each base station 505 may provide communication coverage for a particular geographic area. In 3GPP, the term “cell” may refer to this particular geographic coverage area of a base station or a base station subsystem serving the coverage area, depending on the context in which the term is used. In implementations of wireless network 500 herein, base stations 505 may be associated with a same operator or different operators (e.g., wireless network 500 may include a plurality of operator wireless networks). Additionally, in implementations of wireless network 500 herein, base station 505 may provide wireless communications using one or more of the same frequencies (e.g., one or more frequency bands in licensed spectrum, unlicensed spectrum, or a combination thereof) as a neighboring cell. In some examples, an individual base station 505 or UE 515 may be operated by more than one network operating entity. In some other examples, each base station 505 and UE 515 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 5, base stations 505d and 505e are regular macro base stations, while base stations 505a-505c are macro base stations enabled with one of 3 dimension (3D), full dimension (FD), or massive MIMO. Base stations 505a-505c take advantage of their higher dimension MIMO capabilities to exploit 3D beamforming in both elevation and azimuth beamforming to increase coverage and capacity. Base station 505f is a small cell base station which may be a home node or portable access point. A base station may support one or multiple (e.g., two, three, four, and the like) cells.

Wireless network 500 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 515 are dispersed throughout the wireless network 500, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 515, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc. ; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 515a-515d of the implementation illustrated in FIG. 5 are examples of mobile smart phone-type devices accessing wireless network 500. A UE may also be a machine specifically configured for connected communication, including machine type communication (MTC), enhanced MTC (eMTC), narrowband IoT (NB-IoT) and the like. UEs 515f-515k illustrated in FIG. 5 are examples of various machines configured for communication that access wireless network 500.

A mobile apparatus, such as UEs 515, may be able to communicate with any type of the base stations, whether macro base stations, pico base stations, femto base stations, relays, and the like. In FIG. 5, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 500 may occur using wired or wireless communication links.

In operation at wireless network 500, base stations 505a-505c serve UEs 515a and 515b using 3D beamforming and coordinated spatial techniques, such as coordinated multipoint (CoMP) or multi-connectivity. Macro base station 505d performs backhaul communications with base stations 505a-505c, as well as small cell, base station 505f. Macro base station 505d also transmits multicast services which are subscribed to and received by UEs 515c and 515d. Such multicast services may include mobile television or stream video, or may include other services for providing community information, such as weather emergencies or alerts, such as Amber alerts or gray alerts.

Wireless network 500 of implementations supports communications with ultra-reliable and redundant links for devices. Redundant communication links with a UE include from macro base stations 505d and 505e, as well as small cell base station 505f. Other machine type devices, such as UE 515f (thermometer), UE 515g (smart meter), and UE 515 h (wearable device) may communicate through wireless network 500 either directly with base stations, such as small cell base station 505f, and macro base station 505e, or in multi-hop configurations by communicating with another user device which relays its information to the network, such as UE 515f communicating temperature measurement information to the smart meter, UE 515g, which is then reported to the network through small cell base station 505f. Wireless network 500 may also provide additional network efficiency through dynamic, low-latency TDD communications or low-latency FDD communications, such as in a vehicle-to-vehicle (V2V) mesh network between UEs 515i-515k communicating with macro base station 505e.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably. A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards. A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long-term evolution (LTE) is a release of UMTS that uses E-UTRA. The various different network types may use different radio access technologies (RATs) and RANs.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-2 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIGS. 1, 2, 3, or 4 may be combined with one or more blocks (or operations) described with reference to another of the figures. For example, one or more blocks (or operations) of FIG. 3 may be combined with one or more blocks (or operations) of FIG. 1 or 2.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus. In one or more aspects, techniques for detecting I/O lines that are not meeting a condition (e.g., not operating as expected), may include additional aspects, such as any single aspect or any combination of aspects described below or in connection with one or more other processes or devices described elsewhere herein.

In a first aspect, an apparatus may include one or more memories storing processor-executable code and one or more processors. The one or more processors coupled with the one or more memories and individually or collectively operable to execute the code may cause the apparatus to schedule data to be transmitted over a set of I/O lines in a queue. The one or more processors may be individually or collectively further operable to execute the code to cause the apparatus to determine that a condition is met for the set of I/O lines prior to transmitting the data over the set of I/O lines. The one or more processors may be individually or collectively further operable to execute the code to cause the apparatus to transmit the data over the set of I/O lines in the queue when the condition is met for the set of I/O lines.

In a second aspect, in combination with the first aspect, the data may be transmitted serially.

In a third aspect, in combination with one or more of the first aspect or the second aspect, the one or more processors may be individually or collectively further operable to execute the code to cause the apparatus to reset the set of I/O lines in response to the condition not being met.

In a fourth aspect, in combination with one or more of the first aspect through the third aspect, the one or more processors may be individually or collectively further operable to execute the code to cause the apparatus to transmit an error event notification indicating that the condition is not met for the I/O lines when the condition is not met.

In a fifth aspect, in combination with one or more of the first aspect through the fourth aspect, to determine that the condition is not met for the set of I/O lines maybe based at on an idle low state associated with one or more of the set of I/O lines.

In a sixth aspect, in combination with one or more of the first aspect through the fifth aspect, to determine that the condition is met may occur prior to expiration of a timer associated with transmitting the data over the set of I/O lines.

In a seventh aspect, in combination with one or more of the first aspect through the sixth aspect, to determine that the condition is met for the set of I/O lines may be based on an idle high state associated with each of the set of I/O lines.

In an eighth aspect, in combination with one or more of the first aspect through the seventh aspect, the apparatus may include a programmable serial engine module, where the programmable serial engine module may determine that the condition is met for the set of I/O lines.

In a ninth aspect, in combination with one or more of the first aspect through the eighth aspect, the one or more processors may be individually or collectively further operable to execute the code to cause the apparatus to set a register bit of the programmable serial engine module to indicate an error event when the condition is not met for the I/O lines.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

As used herein, the term “coupled to” in the various tenses of the verb “couple” may mean that element A is directly connected to element B or that other elements may be connected between elements A and B (i.e., that element A is indirectly connected with element B), to operate certain intended functions. In the case of electrical components, the term “coupled to” may also be used herein to mean that a wire, trace, or other electrically conductive material is used to electrically connect elements A and B (and any components electrically connected therebetween). In some examples, the term “coupled to” mean a transfer of electrical energy between elements A and B, to operate certain intended functions.

In some examples, the term “electrically connected” mean having an electric current or configurable to having an electric current flowing between the elements A and B. For example, the elements A and B may be connected via resistors, transistors, or an inductor, in addition to a wire, trace, or other electrically conductive material and components. Furthermore, for radio frequency functions, the elements A and B may be “electrically connected” via a capacitor.

The terms “first,” “second,” “third,” etc. are employed for ease of reference and may not carry substantive meanings. Likewise, names for components/modules may be adopted for ease of reference and might not limit the components/modules. \

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes .1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. An apparatus, comprising:
one or more memories storing processor-executable code; and
one or more processors coupled with the one or more memories and individually or collectively operable to execute the code to cause the apparatus to:
schedule data to be transmitted over a plurality of input/output lines in a queue;
determine that a condition is met for the plurality of input/output lines prior to transmitting the data over the plurality of input/output lines; and
transmit the data over the plurality of input/output lines in the queue when the condition is met for the plurality of input/output lines.

2. The apparatus of claim 1, wherein the data is transmitted serially.

3. The apparatus of claim 1, the one or more processors are individually or collectively further operable to execute the code to cause the apparatus to:
reset the plurality of input/output lines in response to the condition not being met.

4. The apparatus of claim 1, the one or more processors are individually or collectively further operable to execute the code to cause the apparatus to:
transmit an error event notification indicating that the condition is not met for the input/output lines when the condition is not met.

5. The apparatus of claim 1, the one or more processors are individually or collectively further operable to execute the code to cause the apparatus to:
determine that the condition is not met for the plurality of input/output lines based at least in part on an idle low state associated with one or more of the plurality of input/output lines.

6. The apparatus of claim 1, wherein to determine that the condition is met occurs prior to expiration of a timer associated with transmitting the data over the plurality of input/output lines.

7. The apparatus of claim 1, wherein to determine that the condition is met for the plurality of input/output lines is based at least in part on an idle high state associated with each of the plurality of input/output lines.

8. The apparatus of claim 1, wherein the apparatus comprises a programmable serial engine module, and wherein the programmable serial engine module determines that the condition is met for the plurality of input/output lines.

9. The apparatus of claim 8, the one or more processors are individually or collectively further operable to execute the code to cause the apparatus to:
set a register bit of the programmable serial engine module to indicate an error event when the condition is not met for the input/output lines.

10. A method, comprising:
scheduling data to be transmitted over a plurality of input/output lines in a queue at a processing unit;
determining that a condition is met for the plurality of input/output lines prior to transmitting the data over the plurality of input/output lines; and
transmitting the data over the plurality of input/output lines in the queue when the condition is met for the plurality of input/output lines.

11. The method of claim 10, wherein the data is transmitted serially.

12. The method of claim 10, further comprising:
resetting the plurality of input/output lines when the condition is not met.

13. The method of claim 10, further comprising:
transmitting an error event notification indicating that the condition is not met for the input/output lines when the condition is not met.

14. The method of claim 10, further comprising:
determining that the condition is not met for the plurality of input/output lines based at least in part on an idle low state associated with one or more of the plurality of input/output lines.

15. The method of claim 10, wherein determining that the condition is met occurs prior to expiration of a timer associated with transmitting the data over the plurality of input/output lines.

16. The method of claim 10, wherein determining that the condition is met for the plurality of input/output lines is based at least in part on an idle high state associated with each of the plurality of input/output lines.

17. The method of claim 10, further comprising:
setting a register bit of a programmable serial engine module of the processing unit to indicate an error event when the condition is not met for the input/output lines.

18. A non-transitory computer-readable medium storing code for wireless communications, the code comprising instructions executable by one or more processors to:
schedule data to be transmitted over a plurality of input/output lines in a queue;
determine that a condition is met for the plurality of input/output lines prior to transmitting the data over the plurality of input/output lines; and
transmit the data over the plurality of input/output lines in the queue when the condition is met for the plurality of input/output lines.

19. The non-transitory computer-readable medium of claim 18, wherein the data is transmitted serially.

20. The non-transitory computer-readable medium of claim 18, wherein the instructions are further executable by the one or more processors to:
reset the plurality of input/output lines when the condition is not met.
